(19) United States
(12) Patent Application Publication
(10) Pub. No.: US 2002/0158593 A1
(43) Pub. Date: Oct. 31, 2002

(54) Circuit for controlling dynamic braking of a motor shaft in a power tool

(76) Inventors: Jeffery L. Henderson, Somerville, AL (US); Hong Moon, Arab, AL (US); Mark Wardrup, Attalla, AL (US)

Correspondence Address: Tyco Electronics Corporation, Suite 450, 4550 New Linden Hill Road, Wilmington, DE, 19808-2952, US

(21) Appl. No.: 09/844,067

(22) Filed: Apr. 27, 2001

(51) Int. Cl. H02P 3/12; H02P 3/14; H02P 3/18

(52) U.S. Cl. 318/375

(57) ABSTRACT

A circuit for providing a braking force to a power tool is provided comprising a motor adapted to rotate a drive shaft in a power tool, a power supply electronically connected to the motor, and a braking module, located between the motor and the power supply, for applying a current limited braking force to the motor when the power supply is disconnected to the motor.

### BACKGROUND OF THE INVENTION

At least one embodiment of the present invention generally relates to variable speed power tools. More particularly, at least one embodiment of the present invention relates to controlling dynamic braking of electric motors in power tools.

Hand held power tools, such as electric drills and screw drivers, use electric motors to power a chuck holding a tool. Such power tools usually include a trigger which is manually operated by a user with the motor being controlled by the user pressing the trigger. Power tools in which the motor and chuck speed are controlled based on the amount that the trigger is depressed are known as variable speed power tools. In other power tools the trigger turns the motor on and off but does not vary the speed of the motor.

Typically, power tools include motors that are powered by an AC or DC power source that delivers current through commutators and brushes to temporary magnets on the motor rotor shaft. As the user squeezes the trigger, more power is delivered through the brushes and commutator to the temporary magnets to cause the shaft to rotate faster. Once the trigger is released, current is no longer delivered to the motor. However, when the trigger is released, the motor begins to operate as a generator so long as the motor rotates (free wheels). While free wheeling, the motor creates current that passes in the opposite direction through the commutators and brushes.

Conventional power tools typically provide braking of the motor once it is turned off. In many power tools it is desirable to brake the tool in a very short period of time. Variable speed motors may be stopped by electrical means such as by creating an electrical short circuit across the motor when the trigger is released. Actively engaging an electrical means to stop the motor, is known as a dynamic brake. Although dynamic brakes have been provided for braking power tools, such dynamic brakes do so at the expense of the life of the motor.

In conventional dynamic braking circuits, when the direct short circuit is applied across the motor leads, a high current surge is experienced through the motor. The high current surge is caused since the motor attempts to produce current while free wheeling yet the current has no where to flow but through the short circuit. The high current surge causes the magnetic fields of the temporary magnets on the rotor shaft to interfere with permanent magnets surrounding the rotor shaft. The interfering magnetic fields cause the motor to brake rapidly.

However, the current spikes cause a significant amount of wear on the brushes of the motor. The life of the motor is related to the amount of wear that the brushes experience.

A need, therefore, exists for an improved dynamic brake that provides the necessary braking force and reduces damage to and extends the life of the motor.

### BRIEF SUMMARY OF THE INVENTION

In accordance with at least one embodiment of the present invention, a circuit for providing a braking force to a power tool is provided comprising a motor adapted to rotate a drive shaft in a power tool, a power supply electronically connected to the motor, and a braking module, located between the motor and the power supply, for applying a current limited braking force to the motor when the power supply is disconnected to the motor.

One aspect of an embodiment of the present invention is the use of a current limiter for dampening the current induced by the motor while the motor is decelerating to a stopped position. Another aspect of one embodiment of the present invention is the use of a current limit for preventing the current passing through the motor from exceeding a predefined threshold while decelerating the motor to a stopped position. Another aspect of an embodiment of the present invention is the use of a resistive load connected between the terminals of the motor when the power supply is disconnected to induce a braking force on the motor.

One aspect of an embodiment of the present invention is the use of a resistor connected between the terminals of the motor when the power supply is disconnected to induce a braking force on the motor. Optionally, a resistive bank may be connected between the terminals of the motor when the power supply is disconnected to induce a braking force on the motor. Alternatively, a dynamic brake contact may be connected in series with a resistor brake.

Another aspect of an embodiment of the present invention is the use of a power MOSFET connected between the terminals of the motor when the power supply is disconnected to induce a braking force on the motor. Alternatively, a resistive material may be formed of at least one of brass or polymer connected between the terminals of the motor when the power supply is disconnected to induce a braking force on the motor.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there is shown in the drawings, embodiments which are presently preferred. It should be understood, however, that the present invention is not limited to the precise arrangements and instrumentality shown in the attached drawings.

FIG. 1 illustrates a power tool formed according to one embodiment of the present invention.

FIG. 2 illustrates a schematic diagram of a control circuit according to one embodiment of the present invention.

FIG. 3 is a graph of resistance values of a current dampening resistor of one embodiment of the present invention versus the time required to stop the motor.

FIG. 4 is a graph of resistance values of a current dampening resistor of one embodiment of the present invention versus the percentage increase in tool life.

### DETAILED DESCRIPTION OF THE INVENTION

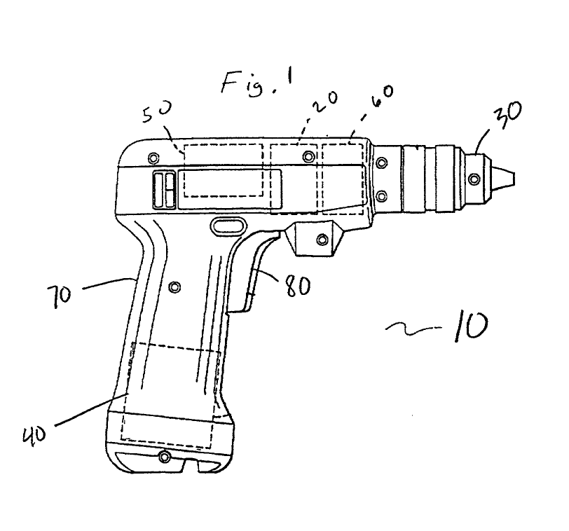

FIG. 1 illustrates an electric power tool 10 with a body 70, a trigger 80, a variable speed motor 20, a chuck 30 for holding a tool, a DC battery 40, a drive shaft 60 and a circuit 50 for braking the motor according to one embodiment of the present invention. The motor 50 of the drill 10 is adapted to drive the chuck 30 through the shaft 60. The trigger 80 allows the user to vary the speed of the chuck 30 by controlling the current from the battery 50 to the motor 20 based on how much the user squeezes the trigger 80.

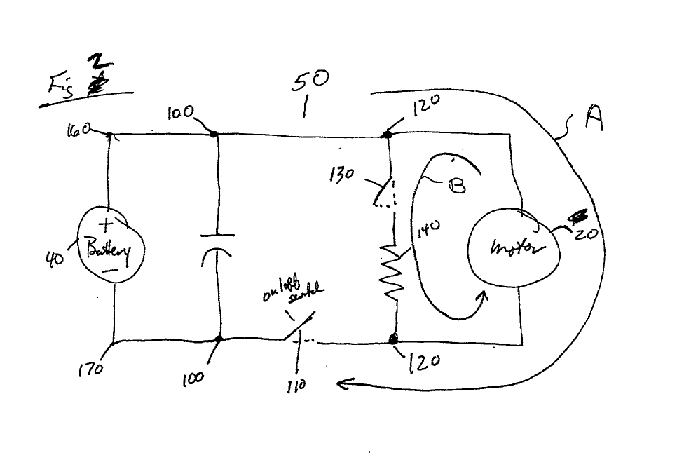

FIG. 2 illustrates the braking circuit 50 formed in accordance with one embodiment of the present invention. The braking circuit 50 includes a DC battery 40, a first set of contacts 100, an on-off switch 110, a second set of contacts 120, a dynamic brake switch 130, a resistor 150 and a motor 20.

The circuit 50 is used to brake the motor 20 after the user has completely released the trigger 80. The DC battery 40 has a positive lead 160 and a negative lead 170 electronically connected to the first set of contacts 100. The on-off switch 110 is controlled by the trigger 80 and is opened when the trigger is released and closed when the trigger is squeezed. The DC battery 40 is attached to, and disconnected from, the motor 20 by the on-off switch 110. The second set of contacts 120 are electrically connected to a dynamic brake switch 130 and a resistor 140 connected in series. Finally, the motor 20 is electrically connected in parallel to the dynamic brake switch 130 and the resistor 140.

In operation, when the user presses the trigger 80 the on-off switch 110 is closed and current flows from the battery 40 to the motor 20 (along path A). The DC battery 40 may include a voltage regulator to regulate the power supplied across the circuit 50 and to the motor 20. Optionally, an AC power source may be used with an AC-to-DC converter to deliver a DC power to the first set of contacts 100. The motor 20 drives the drive shaft 60 which turns the chuck 30 at a speed dependant on the trigger 80 position. When the user completely releases the trigger 80 the on-off switch 110 is opened and the dynamic brake switch 130 is closed. This creates a short circuit across the path between the resistor 140, switch 130 and the motor 20 (along path B), thereby stopping the drive shaft 60 and chuck 30.

When the user presses the trigger 80, the circuit 50 delivers current to the motor 20 which spins the shaft 60. When the user releases the trigger 80 the dynamic brake switch 130 is closed creating a short across the motor 20. This short creates a large current across the motor 20 which damages the motor 20 and can reduce the life of the motor 20.

The resistor 140 reduces and dampens the current applied across the motor 20 when this short circuit is induced to stop the motor 20. By dampening the current across the motor 20, damage to the motor 20 is reduced and the life of the motor 20 is increased.

The resistance value resistor 140 and desired stop time may vary from tool to tool depending on the design of the tool and manufacturer's preference. Different power tools or tools made by different manufacturers may have different current generating characteristics and thus may preferably use different resistance values and/or resistor banks to obtain a desired dampening effect. The resistance value for a specific tool may be determined by first inducing a short circuit across the motor 20 to stop the motor 20, and determining a resistance value that reduces the current on the motor 20 and/or increases the motor 20 life and stops the motor 20 in sufficient time. It will be appreciated that a resistor 140 need not be used. Instead, other devices or components may be used that reduce the peak current on the motor 20 when a short circuit is induced to stop the motor thereby increasing the life of the motor 20.

Optionally, the resistor 140 may be a resistor bank with any number of resistors in series or parallel. Alternatively, a power MOSFET or a resistive material may be used in place of the resistor 140. The resistive material may be either brass, a polymer and the like. Resistor banks and MOSFETs may be adjusted (manually or electrically) to vary the dampening effect on the current pikes experienced during dynamic braking. Alternatively, the MOSFET may be controlled during a dynamic braking operation to yield a first resistance value at the beginning of a braking operation and a different resistance value at the end of the braking operation. The dampening characteristics of the MOSFET may be varied in two or more discrete steps or continuously throughout a braking operation.

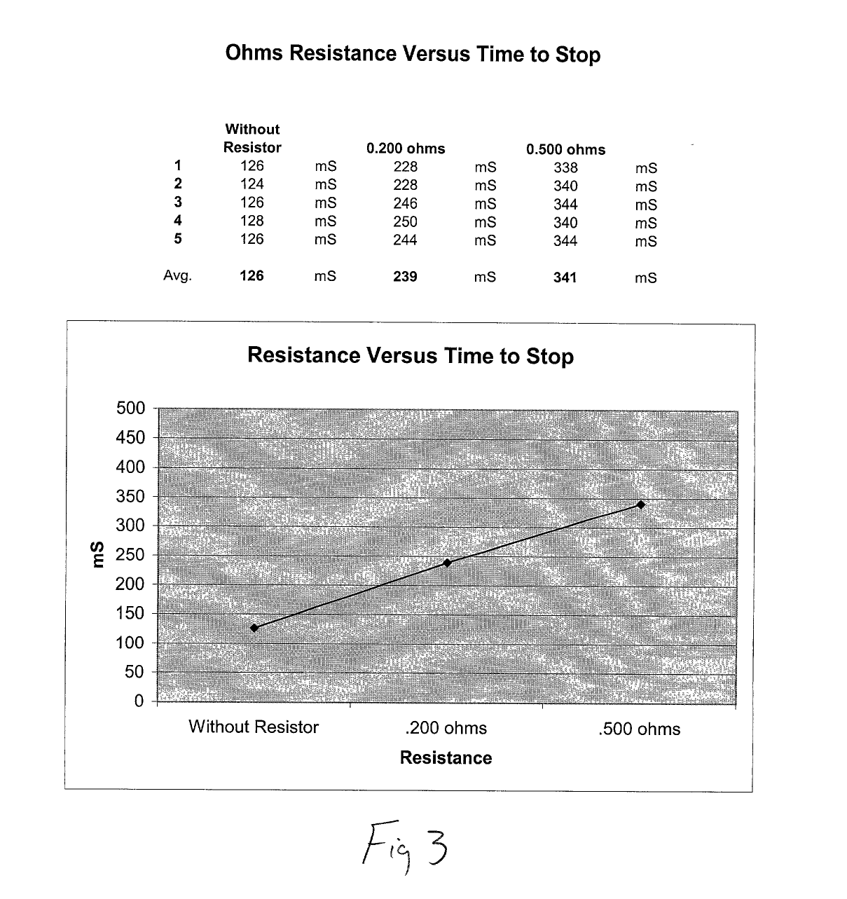

FIG. 3 illustrates the resistance value versus the time to stop the motor 20 (in milliseconds). FIG. 3 demonstrates that a resistance value sufficient to reduce significant loads on the motor can be selected without significantly changing the time to stop the motor 20. The resistor 140 therefore reduces wear on the motor 20 and only increases the time to stop the motor 20 by a negligible amount which is unnoticeable to the user. By way of example only, 0.200 ohm and 0.500 ohm resistors in at least one type of power tool stop the chuck in approximately 250 ms and 350 ms, respectively.

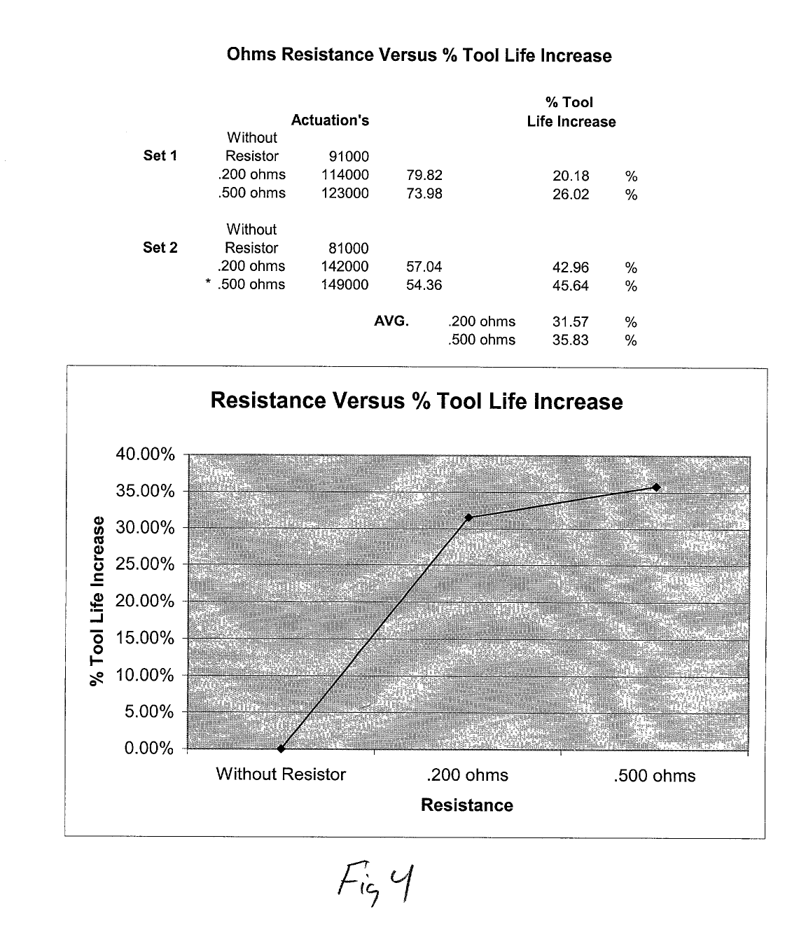

FIG. 4 illustrates the resistance value versus the increase in tool life. FIG. 4 demonstrates that as the resistance value increases, thereby decreasing the load on the motor, tool life is greatly increased. By way of example only, 0.200 ohm and 0.500 ohm resistors in at least one type of power tool increase the tool life by approximately 32% and 36%, respectively.

Finally, the invention is not limited to drills. Instead, in other embodiments, the circuit of FIG. 2 is adaptable to various other types of commercial and residential power tools, such as cordless or AC power screw drivers, saws, and others. Also, the tool need not be variable in speed, but instead merely may have ON and OFF states.

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A circuit for providing a braking force to a power tool, comprising:
a motor adapted to rotate a drive shaft in a power tool;
a power supply electronically connected to said motor;
a braking module, located between said motor and said power supply, for applying a current limited braking force to said motor when said power supply is disconnected from said motor.

2. The circuit of claim 1, wherein said braking module includes a current limiter for dampening the current induced by said motor while decelerating to a stopped position.

3. The circuit of claim 1, wherein said braking module includes a current limiter for preventing the current passing through said motor from exceeding a predefined threshold while decelerating to a stopped position.

4. The circuit of claim 1, further comprising a resistive load connected between terminals of said motor when said power supply is disconnected to induce a braking force on said motor.

5. The circuit of claim 1, further comprising a resistor connected between terminals of said motor when said power supply is disconnected to induce a braking force on said motor.

6. The circuit of claim 1, further comprising a resistive bank connected between terminals of said motor when said power supply is disconnected to induce a braking force on said motor.

7. The circuit of claim 1, further comprising a dynamic brake contact connected in series with a resistor bank.

8. The circuit of claim 1, further comprising a power MOSFET connected between terminals of said motor when said power supply is disconnected to induce a braking force on said motor.

9. The circuit of claim 1, further comprising a resistive material formed of at least one of brass or polymer connected between terminals of said motor when said power supply is disconnected to induce a braking force on said motor.

10. The circuit of claim 1, wherein said power supply includes an AC/DC converter accepting power from an AC source.

11. A power tool, comprising:
a chuck holding a tool;
a motor;
a power supply;
a braking module, located between said motor and said power supply, for applying a current limited braking force to said motor when said power supply is disconnected from said motor.

12. The circuit of claim 11, wherein said braking module includes a current limiter for dampening the current induced by said motor while decelerating to a stopped position.

13. The circuit of claim 11, wherein said braking module includes a current limiter for preventing the current passing through said motor from exceeding a predefined threshold while decelerating to a stopped position.

14. The circuit of claim 11, further comprising a resistive load connected between terminals of said motor when said power supply is disconnected to induce a braking force on said motor.

15. The circuit of claim 11, further comprising a resistor connected between terminals of said motor when said power supply is disconnected to induce a braking force on said motor.

16. The circuit of claim 11, further comprising a resistive bank connected between terminals of said motor when said power supply is disconnected to induce a braking force on said motor.

17. The circuit of claim 11, further comprising a dynamic brake contact connected in series with a resistor bank.

18. The circuit of claim 11, further comprising a power MOSFET connected between terminals of said motor when said power supply is disconnected to induce a braking force on said motor.

19. The circuit of claim 11, further comprising a resistive material formed of at least one of brass or polymer connected between terminals of said motor when said power supply is disconnected to induce a braking force on said motor.

20. The circuit of claim 11, wherein said power supply includes an AC/DC converter accepting power from an AC source.

21. A braking circuit for providing a braking force to a motor of a power tool when the motor is disconnected from a power supply, the braking circuit comprising:
a braking module having input and output terminals adapted to be electronically connected to a motor, said module applying a current limited braking force to said motor when said power supply is disconnected from said motor.

22. The circuit of claim 21, wherein said braking module includes a current limiter for dampening the current induced by said motor while decelerating to a stopped position.

23. The circuit of claim 21, wherein said braking module includes a current limiter for preventing the current passing through said motor from exceeding a predefined threshold while decelerating to a stopped position.

24. The circuit of claim 21, further comprising a resistive load connected between terminals of said motor when said power supply is disconnected to induce a braking force on said motor.

25. The circuit of claim 21, further comprising a resistor connected between terminals of said motor when said power supply is disconnected to induce a braking force on said motor.

26. The circuit of claim 21, further comprising a resistive bank connected between terminals of said motor when said power supply is disconnected to induce a braking force on said motor.

27. The circuit of claim 21, further comprising a dynamic brake contact connected in series with a resistor bank.

28. The circuit of claim 21, further comprising a power MOSFET connected between terminals of said motor when said power supply is disconnected to induce a braking force on said motor.

29. The circuit of claim 21, further comprising a resistive material formed of at least one of brass or polymer connected between terminals of said motor when said power supply is disconnected to induce a braking force on said motor.

30. The circuit of claim 21, wherein said power supply includes an AC/DC converter accepting power from an AC source.

31. A circuit for limiting current flow through a power tool during deceleration of the motor when the power supply is disconnected, comprising:
a motor adapted to rotate a drive shaft in a power tool;
a power supply electronically connected to said motor;
a current limiting switch, located between a motor and a power supply, for limiting the current passed through said motor when said power supply is disconnected from said motor.

32. The circuit of claim 31, wherein said current limiting switch includes a current limiter for dampening the current induced by said motor while decelerating to a stopped position.

33. The circuit of claim 31, wherein said current limiting switch includes a current limiter for preventing the current passing through said motor from exceeding a predefined threshold while decelerating to a stopped position.

34. The circuit of claim 31, further comprising a resistive load connected between terminals of said motor when said power supply is disconnected to induce a braking force on said motor.

35. The circuit of claim 31, further comprising a resistor connected between terminals of said motor when said power supply is disconnected to induce a braking force on said motor.

36. The circuit of claim 31, further comprising a resistive bank connected between terminals of said motor when said power supply is disconnected to induce a braking force on said motor.

37. The circuit of claim 31, further comprising a dynamic brake contact connected in series with a resistor bank.

38. The circuit of claim 31, further comprising a power MOSFET connected between terminals of said motor when said power supply is disconnected to induce a braking force on said motor.

39. The circuit of claim 31, further comprising a resistive material formed of at least one of brass or polymer connected between terminals of said motor when said power supply is disconnected to induce a braking force on said motor.

40. The circuit of claim 31, wherein said power supply includes an AC/DC converter accepting power from an AC source.
